(19) United States
(12) Patent Application Publication
(10) Pub. No.: US 2025/0080922 A1
(43) Pub. Date: Mar. 6, 2025

(54) METHOD FOR DIRECTIONAL SIGNAL PROCESSING FOR A HEARING SYSTEM

(71) Applicant: Sivantos Pte. Ltd., Singapore (SG)

(72) Inventors: Cecil WILSON, Erlangen (DE); Homayoun KAMKAR-PARSI, Erlangen (DE); Christoph LÜKEN, Erlangen (DE)

(21) Appl. No.: 18/823,992

(22) Filed: Sep. 4, 2024

(30) Foreign Application Priority Data
Sep. 4, 2023 (DE) 10 2023 208 468.6

(51) Int. Cl. H04R 25/00

(52) U.S. Cl. CPC H04R 25/405; H04R 25/407; H04R 2430/20

(57) ABSTRACT

A method for directional signal processing for a hearing system having at least a first hearing instrument. A first input signal is generated from an ambient sound by an electroacoustic first input transducer of the first hearing instrument, and a second input signal is generated by an electroacoustic second input transducer of the hearing system. A number of interlocutors of a wearer of the hearing system is determined on the basis of the first input signal and on the basis of the second input signal. At least a compression and/or a directional microphony and/or a noise suppression is/are modified in the processing of the first input signal and/or the second input signal depending on the determined number of interlocutors, and a first output signal is thereby generated.

The invention relates to a method for directional signal processing for a hearing system having at least a first hearing instrument, wherein a first input signal is generated from an ambient sound by an electroacoustic first input transducer of the first hearing instrument, and a second input signal is generated by an electroacoustic second input transducer of the hearing system, wherein a first output signal is generated depending on a processing of the first input signal and/or the second input signal.

In a hearing device for treating a hearing impairment, one of the most difficult challenges is to support a person with damaged hearing in a conversation with a plurality of potential interlocutors (e.g. the “cocktail party” hearing situation). Here, a plurality of useful signals which are produced in the conversation contributions of the interlocutors usually have to be separated from a noisy background which, on one hand, may possibly contain undefined through to fragmented speech signals, and which furthermore usually has no clearly defined sources.

In a dialog, a person with damaged hearing can usually concentrate fully on the conversation with the single interlocutor, so that he can also pay particular attention to non-verbal communication elements such as gestures and/or mimicry of the interlocutor, and to direct interaction with the interlocutor (i.e., for example, short, reciprocal interjections or the like). A dialog can be supported here by a hearing aid through a particular accentuation of the speech contributions of the single interlocutor in an efficiently solvable manner.

However, in the case of a plurality of interlocutors, support by a hearing device is usually made more difficult either by the fact that the individual conversation contributions cannot be satisfactorily accentuated against background noise, or that an accentuation of this type can result in an unnaturally sounding and therefore unpleasant background. Moreover, one of the interlocutors is often not located in the frontal direction of the person with damaged hearing, as a result of which non-verbal communication elements are not perceived to the same extent as in the case of a dialog. This, and also a potentially lacking synchronization by “taking turns” when speaking can require a substantial effort on the part of a person with damaged hearing, so that he increasingly withdraws from the communication, or even drops out of the conversation entirely as he is becoming less and less capable of following it.

The invention is therefore based on the object of indicating a method for a hearing instrument, wherein support of a person with damaged hearing is achievable in the most targeted manner possible in complex conversation situations by means of said method, whilst the background is intended to remain as natural as possible here.

The aforementioned object is achieved according to the invention by a method for directional signal processing for a hearing system having a first hearing instrument, wherein a first input signal is generated from an ambient sound by an electroacoustic first input transducer of the first hearing instrument, and a second input signal is generated by an electroacoustic second input transducer of the hearing system, wherein the number of interlocutors of a wearer of the hearing system is determined on the basis of the first input signal and on the basis of the second input signal, and wherein at least a compression and/or a directional microphony and/or a noise suppression is/are modified in the processing of the first input signal and/or the second input signal depending on the determined number of interlocutors, and a first output signal is thereby generated. Advantageous designs, in part inventive per se, form the subject-matter of the subclaims and the following description.

A hearing instrument generally comprises here any device that is configured to generate an electrical signal from an ambient signal by means of an input transducer, and to process this signal to form an output signal, and to generate an output sound signal from the output signal and feed it to the hearing of a wearer of this device. A hearing instrument comprises, in particular, a headphone (e.g. as an earbud), a headset, data glasses with a loudspeaker, etc. However, a hearing instrument also comprises a hearing device in the narrower sense, i.e. a device for treating a hearing impairment of the wearer, in which one or more input signals is processed depending on audiological requirements of the wearer to form said output signal and, in particular, is amplified depending on the frequency band so that the output sound signal generated from the output signal by means of a loudspeaker or the like is suitable, in particular, for at least partially compensating the impaired hearing of the wearer, particularly in a user-specific manner.

An electroacoustic input transducer comprises here, in particular, any device that is configured to generate a corresponding electrical signal from a sound signal. In particular, during the generation of the first or second input signal, preprocessing can also be carried out by the respective input transducer, e.g. in the form of a linear pre-amplification and/or an A/D conversion. The correspondingly generated input signal comprises, in particular, an electrical signal of which the current fluctuations and/or voltage fluctuations essentially represent the sound pressure fluctuations of the air.

The hearing system can comprise here, on one hand, only the first hearing instrument. In this case, the second input transducer is similarly arranged in the first hearing instrument. The number of interlocutors can then be determined, in particular, on the basis of (monaural) directional microphony and/or other directional signal processing, wherein, in particular, spectral analyses of the input signals can additionally be used.

However, the hearing system is preferably designed as a binaural hearing system which comprises the first hearing instrument and a second hearing instrument which are to be worn in each case on one ear or on the other ear, wherein the second input signal is generated by the second input transducer of the second hearing instrument. In this case, the number of interlocutors can be determined, in particular, on the basis of directional processing of the two input signals, in that, for example, intermediate signals having different directional characteristics are generated in each case on the basis of the two input signals by means of directional microphony, and the intermediate signals are used to detect the interlocutors.

The signal processing is normally performed in a hearing instrument, in particular in a hearing device for treating impaired hearing, depending on classified “hearing situations”. These hearing situations are standardized types of possible acoustic environments which are determined and classified on the basis of specific features that are measurable in the hearing instrument, such as the signal-to-noise ratio (SNR), the speech component, the speech intelligibility index (SII) or the like.

However, in complex hearing situations involving a plurality of interlocutors in the presence of background noises (which may similarly contain speech signals which are, however, irrelevant to the wearer) this classification can result, on one hand, in overaggressive noise suppression and/or directional microphony so that an unnatural sound impression is produced, and furthermore an interlocutor standing to the side may not be captured at all by the directional microphony, or, on the other hand, individual conversation contributions are not sufficiently accentuated.

The invention solves this problem by examining the acoustic characteristics of a situation in order to determine how many interlocutors are engaged in conversation with the wearer of the hearing instrument or hearing system. In particular, a different signal processing is explicitly applied here in the case of one interlocutor on one hand, and in the case of two or more interlocutors on the other hand. In the case of two or more interlocutors, the signal processing is also preferably applied in a differentiated manner on a case-by-case basis, i.e., in particular, the case of two interlocutors is differentiated from the case of three or more interlocutors.

A modification of a compression and/or a directional microphony and/or a noise suppression in the processing of the first input signal and/or the second input signal comprises here, in particular, deriving an intermediate signal from the first input signal and/or from the second input signal, in particular also using the signal components of still further input signals, and setting the compression or noise suppression for this intermediate signal depending on the number of interlocutors. In particular, the intermediate signal can further be provided by a directional signal.

This entails, in particular, applying a specific value to a parameter of the compression or the noise suppression or the directional microphony in the case of only one identified interlocutor and an otherwise given acoustic situation, and assigning a different, correspondingly associated, value to the parameter in the case of two or more identified interlocutors. The first output signal is then preferably generated on the basis of the intermediate signal, or is formed directly by the same.

When determining the number of interlocutors, the speech activity of a determined interlocutor is preferably dynamically taken into account, in that, after a predefined time without speech activity, i.e., for example, after at least 100 ms, preferably 1 s, and particularly preferably 3 s, and at most three minutes, preferably at most one minute and particularly at most 10 s, a person is no longer counted as an interlocutor. Consequently, after such a time period without a corresponding speech contribution from a person who was regarded until then as an interlocutor, the number of interlocutors is therefore preferably reduced by 1 (unless a new interlocutor joins in).

A first half-space signal and a second half-space signal are preferably generated by directional microphony on the basis of the first input signal and the second input signal, wherein the compression and/or directional microphony and/or noise suppression is/are applied to the first or second half-space signal, and/or is/are applied separately to each of the two half-space signals. Here, in particular, the respective half-space signal attenuates sound from one half-space to a substantial, preferably maximum, extent, and correspondingly makes significant contributions only for sound from the other half-space (which is therefore complementary to the above-mentioned half-space). In particular, the first half-space for which the first half-space signal makes significant contributions can be complementary to the second half-space which makes significant contributions for the second half-space signal (but not for the first half-space signal). In particular, the first and/or the second half-space signal can also be generated on the basis of one or more intermediate signals, wherein the or each intermediate signal is generated on the basis of the first and the second input signal, in particular by means of directional microphony. The half-space signals are an advantageous type of preprocessing to which further signal processing can then be applied depending on the number of interlocutors in order to improve the intelligibility of the interlocutors.

The first half-space signal preferably has a directional characteristic which attenuates a rear half-space to the maximum extent, and/or the second half-space signal has a directional characteristic which attenuates a front half-space to the maximum extent, wherein the front and the rear half-spaces are defined in relation to a frontal direction of the wearer. This means, in particular, that the aforementioned first half-space (for which only the first half-space signal makes significant contributions) is formed by the front half-space, defined in relation to the frontal direction of the wearer (when the hearing system is worn in the intended manner), and the aforementioned second half-space (for which only the second half-space signal makes significant contributions) is formed by the rear half-space.

A first alternative input signal is favorably generated from the ambient sound by a first alternative input transducer of the first hearing instrument, and a second alternative input signal is preferably generated by a second alternative input transducer of the second hearing instrument, wherein the number of interlocutors of the wearer of the binaural hearing system is additionally determined on the basis of the first alternative input signal and/or the second alternative input signal. This means, in particular, that the binaural hearing system in each case generates two input signals in each of the two hearing instruments, wherein, if necessary, a local preprocessing can be applied (through directional microphony) to said input signals. The number of interlocutors is determined at least in one (in the first) hearing instrument at least on the basis of the two local input signals (the first input signal and the first alternative input signal), and at least one input signal (the second input signal), preferably on the basis of both input signals (i.e. the second alternative input signal also), of the other hearing instrument (the second hearing instrument), wherein, in particular, the respective input signals (or an intermediate signal derived therefrom which, if necessary, can be generated by means of local directional microphony) can be transmitted for this purpose to the respective other hearing instrument. A particularly precise determination, in particular of a position of an interlocutor, can be carried out by means of the alternative input signals following the procedure described here.

The first output signal is also preferably generated on the basis of the first input signal and the first alternative input signal, and in particular on the basis of the second input signal and/or the second alternative input signal. Here, in particular, the signal components of the same input signals which are also used to determine the number of interlocutors are incorporated into the first output signal.

A speech component in the ambient sound is favorably monitored on the basis of the first and second input signal, preferably also on the basis of the first and/or second alternative input signal, wherein a spatial analysis is carried out on the basis of the first and second input signal in order to determine the number and the position of the interlocutors, and, in particular, an angle direction of the sound source of the ambient sound is determined for this purpose, and wherein a presence and a position of a single speaker are determined on the basis of the speech component and the angle direction. This is advantageous, in particular, as a preliminary stage for determining the number of interlocutors. In particular, a spectral analysis is applied to individual speech components in order to achieve a better differentiation of different speakers from one another.

In a further step, a length of a conversation contribution and/or an overlap of a conversation contribution with a conversation contribution of the wearer is advantageously determined on the basis of the first and second input signal, and preferably also on the basis of the first and/or second alternative input signal, for said individual speakers, and the individual speaker is identified therefrom as an interlocutor of the wearer. Speakers, in particular, who are engaged in other conversations in a complex acoustic environment and are not therefore interlocutors of the wearer can thereby be filtered out.

The presence and position of the individual speaker are appropriately determined in only one half-space which corresponds to one of the two half-space signals. A prefiltering of the acoustic environment can thereby be achieved, in particular, for a determination in the front half-space.

Moreover, it proves to be further advantageous if a change in a position of the individual speaker is tracked. This can be done, for example, by means of a sufficiently frequent updating of the position. By tracking his position, an interlocutor, once detected, can remain identified as such without the need to continuously perform a new comprehensive analysis in respect of his spectral frequency components in the speech component or in respect of the overlap of his conversation contributions.

In one advantageous embodiment, if only one interlocutor is detected, a predefined first value of an amplification parameter is applied to an intermediate signal generated on the basis of the first and/or second input signal, and, if precisely two interlocutors are detected, a second value of the amplification parameter is applied to the intermediate signal, said second value being 2 dB to 5 dB lower than the first value, and/or if precisely three interlocutors are detected, a third value of the amplification parameter is applied to the intermediate signal, said third value being 4 dB to 10 dB lower than the first value. The intermediate signal can be formed here, in particular, by a directional signal, and, in particular, can be incorporated into the first output signal, wherein, if necessary, an additional frequency-band-dependent amplification and/or compression is applied to the intermediate signal.

A quantitatively different signal processing is preferably performed in each case for one, two or three interlocutors, in particular in that a more substantial noise suppression is applied if more interlocutors are present. From three interlocutors upwards, the signal processing can, in particular, also remain constant.

An amplification and/or a noise amplification and/or an offset of a background amplification is/are preferably used as an amplification factor for the second half-space signal which has a directional characteristic which attenuates a front half-space to the maximum extent. This means that sound from the rear half-space is increasingly attenuated as the number of interlocutors increases.

The invention further cites a hearing system having at least a first hearing instrument, wherein the hearing system is configured to carry out the method described above. The hearing system is preferably designed as a binaural hearing system which further comprises a second hearing instrument.

The hearing system according to the invention shares the advantages of the method according to the invention. The advantages indicated for the method and for its developments can be transferred accordingly to the hearing system.

An exemplary embodiment of the invention is explained in detail below with reference to drawings, in which:

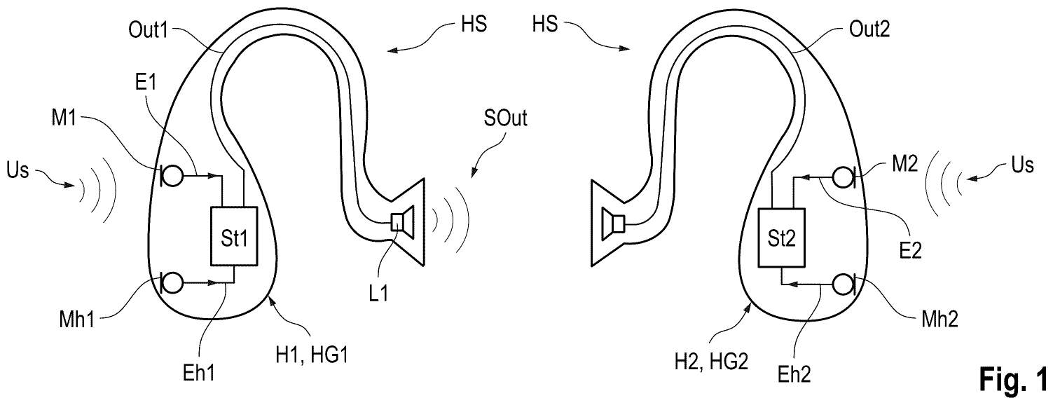

FIG. 1 shows schematically a block diagram of a binaural hearing system having two hearing devices,

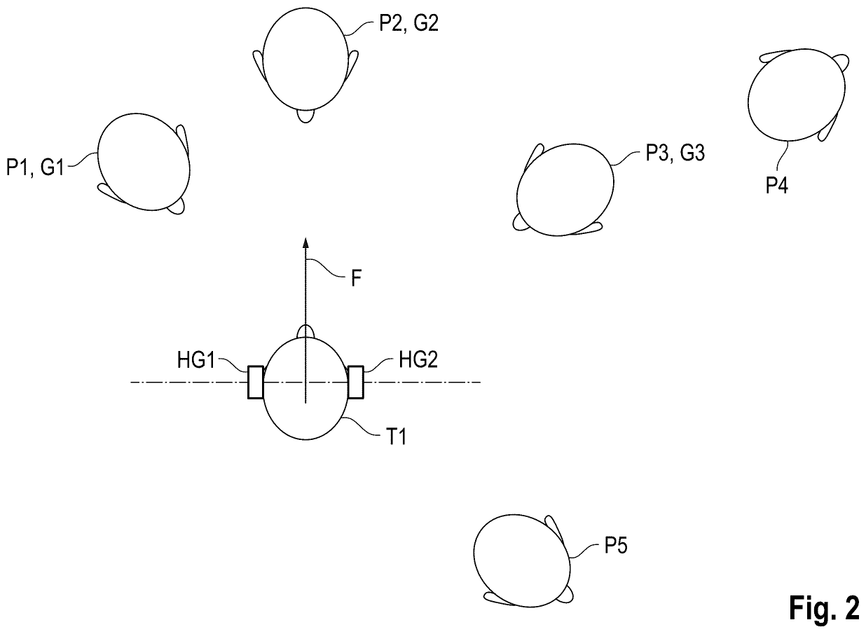

FIG. 2 shows schematically a top view of a wearer of the binaural hearing system according to FIG. 1, and also his environment, and

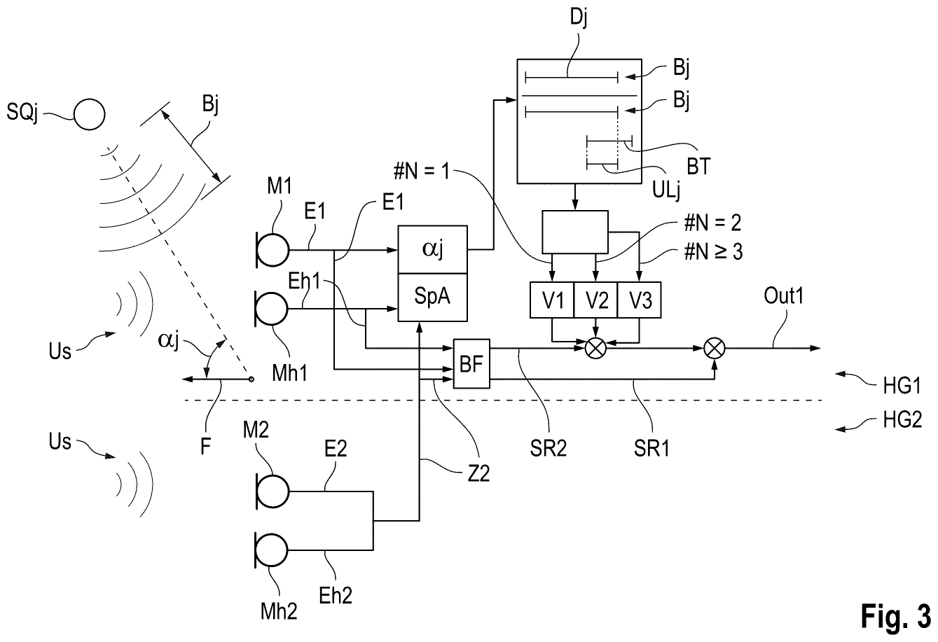

FIG. 3 shows schematically a block diagram of the sequence of a method for signal processing for the binaural hearing system according to FIG. 1 depending on the interlocutors in the environment according to FIG. 2.

Matching parts and variables are denoted in each case with the same reference numbers in all figures.

FIG. 1 shows schematically a block diagram of a binaural hearing system HS having a first hearing instrument H1 and a second hearing instrument H2. The two hearing instruments H1, H2 are designed here as a first and second hearing device HG1, HG2, which are configured and provided for treating a hearing impairment of the wearer of the binaural hearing system HS. The first hearing device HG1 has a first input transducer M1 and a first alternative input transducer Mh1, while the second hearing device HG2 has a second input transducer M2 and a second alternative input transducer Mh2. Said input transducers are formed in each case by corresponding microphones.

The first input transducer M1 and the first alternative input transducer Mh1 are configured in each case to generate a first input signal E1 or a first alternative input signal Eh1 from an ambient sound Us. The second input transducer M2 and the second alternative input transducer Mh2 are in each case configured accordingly to generate a second input signal E2 or a second alternative input signal Eh2 from the ambient sound Us.

The first hearing device HG1 has a first control unit St1 which processes the first input signal E1 and the first alternative input signal Eh1 in a manner still to be described in order to form a first output signal Out1 which is converted by a first output transducer L1 of the first hearing device HG1 into a first output sound signal Sout1. The first output transducer L1 is formed here by a loudspeaker. However, the first output transducer L1 could equally be formed by a bone-conduction receiver. The second hearing device correspondingly comprises a second control unit St2 which processes the second input signal E2 and the second alternative input signal Eh2 to form a second output signal Out2. The second output signal Out2 is converted by a second output transducer (not shown) of the second hearing device HG2 into a second output sound signal.

FIG. 2 shows a top view of a wearer T1 of the binaural hearing system HS according to FIG. 1. Persons P1-P5 are present in an environment of the wearer, wherein still further persons (not shown) can also be present, in particular outside the illustrated section. The persons P1-P5 are engaged in part in conversations with one another, or with the wearer T1, wherein, in addition, background noises which are not yet represented in detail (e.g. due to more distant or no longer localizable conversations, or due to traffic noise or other ambient noise) can also be present. The persons P1, P2, P3 who are located in a front half-space R1 in relation to a frontal direction F of the wearer T1 are engaged in conversation with the wearer T1, and are therefore to be regarded as his interlocutors G1, G2, G3. The person P4, who is similarly located in the front half-space R1 of the wearer T1, is participating in a different conversation. The person P5 is located in the rear half-space R2 of the wearer T1 which is complementary to the front half-space R1 and is consequently not involved in the conversation with the wearer, but is engaged in a different conversation (the corresponding interlocutors of the persons P4 and P5 are not shown in FIG. 2).

The multiplicity of conversations surrounding him (here, by way of example, the conversations of the persons P4 and P5) and additional background noises make it difficult for the wearer T1 to follow his own conversation with his interlocutors G1-G3. He may have to concentrate harder, is less able to observe the non-verbal communication elements (e.g. justice, mimicry) of the interlocutors G1-G3, and is therefore potentially restricted in terms of his complete involvement in the conversation.

To solve this problem, a method is proposed which is explained with reference to a block diagram shown in FIG. 3.

As described in FIG. 1, the first input signal E1 and the first alternative input signal Eh1 are generated in the first hearing device HG1 from the ambient sound Us, and the second input signal E2 and the second alternative input signal Eh2 are generated in the second hearing device HG2. The ambient sound Us comprises the conversation contributions of the persons P1-P5, and also still further localized and/or diffuse background noises.

The number of interlocutors of the wearer T1 for the situation described in FIG. 2 is now determined on the basis of said input signals E1, E2, Eh1, Eh2. To do this, the input signals E2, Eh2 generated in the second hearing device and/or a second intermediate signal Z2 generated from said input signals E2, Eh2 by means of a local preprocessing are transmitted by means of suitable communication devices (not shown) of the two hearing devices HG1, HG2 from the second hearing device HG2 to the first hearing device HG1. In the present exemplary embodiment, only said second intermediate signal Z2 is transmitted, whereas the input signals E2, Eh2 of the second hearing device HG2 are not transmitted to the first hearing device.

Angle directions αj of individual sound sources SQj and speech components SpA are then determined in each case on the basis of the first input signal E1 and the first alternative input signal Eh1 and also on the basis of the second input signal E2 and the second alternative input signal Eh2 (in particular in the form of the second intermediate signal Z2). For this purpose, for example, a directional signal having a variable maximum direction (lobe-shaped directional signal) or having a variable minimum direction (notch-shaped directional signal) can be generated from said input signals E1, Eh1, E2, Eh2 or Z2. In particular, the angle direction αj of a sound source SQj can initially be determined here, and the speech component SpA can then be defined for this sound source SQj in order to identify whether the sound source SQj is a speaker. The presence and the position of individual speakers in the environment of the wearer T1 are thereby determined. In particular, individual speakers can be distinguished from one another by means of a spectral analysis of the speech components SpA.

In order to then identify whether speech contributions Bj of a speaker determined and localized as described are associated with a conversation with the wearer T1, and the speaker is therefore an interlocutor Gj of the wearer T1, lengths Dj of the speech contributions Bj are determined, and a respective overlap ULj of the speech contributions Bj with speech contributions BT of the wearer T1 is determined. An overlap ULj for an interlocutor Gj can occur up to a suitably chosen limit value, since individual interjections by the participants can be expected repeatedly in a conversation, wherein said overlap ULj also repeatedly redefines the sequence of speaking. However, if the overlap ULj exceeds this limit value, which can also be chosen, in particular, depending on a length Dj of the respective speech contribution Bj, it can be assumed that this speech contribution Bj is determined for a conversation other than the conversation with the wearer T1. The speaker is correspondingly not counted as an interlocutor. In particular, the position of an interlocutor Gj, once detected and localized, can be tracked (not shown) in order to avoid having to repeat the resource-intensive verification of his speech contributions Bj.

The individual interlocutors Gj of the wearer T1, and therefore also the number #N thereof, can be identified in the described manner. In particular, the determination of the number of interlocutors can be restricted to the front half-space R1 (e.g. by actually identifying and localizing sound sources SQj in the front half-space R1 only).

The first output signal Out1 is then generated on the basis of the aforementioned input signals E1, Eh1, E2, Eh2, depending on said number #N of interlocutors Gj. To do this, a first half-space signal SR1 is generated in the first hearing device HG1 (i.e., in particular, in the first control unit St1) on the basis of said input signals E1, Eh1, E2, Eh2 (the input signals E2, Eh2 of the second hearing device HG2 can be preprocessed here, in particular, to form the second intermediate signal Z2) by means of a directional microphony BF, wherein said first half-space signal SR1 makes significant contributions only for sound sources SQj from the front half-space R1, which is defined here as the first half-space, and largely completely attenuates sound sources SQj from the rear half-space R2, which is defined here as the second half-space (wherein, if necessary, a narrow transitional region, such as, for example, an angle expansion of 10°-20°, exists between the first and the second half-space, the sound sources of which are incorporated to a reduced extent into the first half-space signal SR1). The first half-space signal SR1 is therefore a directional signal into which the signal components of the input signals E1, Eh1, E2, Eh2 are incorporated (possibly following local preprocessing to form the second intermediate signal Z2, and possibly also to form a first intermediate signal from the input signals E1, Eh1).

In a comparable manner, a second half-space signal SR2 is generated from said input signals E1, Eh1, E2, Eh2 by means of the directional microphony BF, wherein said second half-space signal SR2 makes significant contributions only for sound sources SQj from the front half-space R2, and largely completely attenuates sound sources SQj from the front half-space R1 (wherein a narrow transitional region possibly likewise exists between the first and the second half-space, the sound sources of which are incorporated to a reduced extent into the second half-space signal SR2).

An amplification value V1, V2 or V3 for #N=1, #N=2 or #N≥3 is then applied to the second half-space signal SR2 depending on the number #N of interlocutors Gj (i.e., in the described dependency, a specific value for an amplification applied to the second half-space signal SR2). This can be done, in particular, in a frequency-band-dependent manner. The second half-space signal SR2 amplified in this way is combined with the first half-space signal SR1, and the first output signal Out1 is generated therefrom (some frequency-dependent amplification or compression of the signal combined from SR1 and SR2 is still possible, but is not shown separately in FIG. 3).

In a manner similar to the described procedure, a compression can also be applied depending on the number #N of interlocutors Gj by applying, e.g. for one, two and three (or even more interlocutors), successive shorter attack constants and/or a higher compression ratio to a first intermediate signal Z1 derived from the first input signal E1 and from the first alternative input signal Eh1, or to the first half-space signal SR1. Further possibilities for signal processing depending on the number #N of interlocutors Gj are conceivable for generating the first output signal Out1.

Although the invention has been illustrated and described in greater detail by means of the preferred exemplary embodiment, the invention is not limited by the disclosed examples and other variations may be derived therefrom by a person skilled in the art without departing the protective scope of the invention.

### REFERENCE SIGN LIST

BF Directional microphony
Bj Speech contribution
BT Speech contribution (of the wearer)
Dj Length (of the speech contribution Bj)
E1/2 First/second input signal
Eh1/2 First/second alternative input signal
F Frontal direction
G1-3, Gj Interlocutor
H1/2 First/second hearing instrument
HG1/2 First/second hearing device
HS Binaural hearing system
L1 First output transducer
M1/2 First/second input transducer
Mh1/2 First/second alternative input transducer
Out1/2 First/second output signal
P1-5 Person
R1/2 Front/rear half-space
Sout1 First output sound signal
SpA Speech component
SQj Sound source
SR1/2 First/second half-space signal
St1/2 First/second control unit
T1 Wearer
Us Ambient sound
ULj Overlap
V1-3 Amplification value
Z2 Second intermediate signal
#N Number of interlocutors
αJ Angle direction

1-14. (canceled)

15. A method for directional signal processing for a hearing system having at least a first hearing instrument, the method comprising:
generating a first input signal from an ambient sound by an electroacoustic first input transducer of the first hearing instrument, and generating a second input signal by an electroacoustic second input transducer of the hearing system;
determining a number of interlocutors of a wearer of the hearing system based on the first input signal and based on the second input signal;
modifying at least one parameter selected from the group consisting of a compression, a directional microphony, and a noise suppression in processing at least one of the first input signal or the second input signal depending on the determined number of interlocutors for generating a first output signal.

16. The method according to claim 15, wherein:
the hearing system is a binaural hearing system having the first hearing instrument and a second hearing instrument; and
the second input signal is generated by a second input transducer of the second hearing instrument.

17. The method according to claim 15, which comprises:
generating at least one of a first half-space signal or a second half-space signal in each case by the directional microphony based on the first input signal and the second input signal; and
depending on the determined number of interlocutors, applying at least one of the compression, the directional microphony, or the noise suppression,
to the first half-space signal or the second half-space signal; or
separately to each of the first half-space signal or the second half-space signal.

18. The method according to claim 17, wherein:
the first half-space signal has a directional characteristic which attenuates a rear half-space to a maximum extent, and/or the second half-space signal has a directional characteristic which attenuates a front half-space to a maximum extent; and
the front half-space and the rear half-space are defined in relation to a frontal direction of the wearer.

19. The method according to claim 16, which comprises:
generating at least one of a first alternative input signal from the ambient sound by a first alternative input transducer of the first hearing instrument or a second alternative input signal by a second alternative input transducer of the second hearing instrument; and
additionally determining the number of interlocutors of the wearer of the binaural hearing system based on at least one of the first alternative input signal or the second alternative input signal.

20. The method according to claim 19, which comprises generating the first output signal on a basis of the first input signal and the first alternative input signal, and on a basis of at least one of the second input signal or the second alternative input signal.

21. The method according to claim 16, which comprises:
monitoring a speech component in the ambient sound on a basis of the first and second input signals;
determining an angular direction of a sound source of the ambient sound on a basis of the first and second input signals; and
determining a presence and a position of an individual speaker based on the speech component and the angular direction.

22. The method according to claim 21, which comprises:
based on the first and second input signals, determining for the individual speaker at least one of:
a length of a conversation contribution; or
an overlap of a conversation contribution with a conversation contribution of the wearer; and
identifying the individual speaker therefrom as an interlocutor of the wearer.

23. The method according to claim 21, which comprises determining the presence and the position of the individual speaker in only one half-space which corresponds to one of two half-space signals.

24. The method according to claim 21, which comprises tracking a change in a position of the individual speaker.

25. The method according to claim 15, which comprises:
if only one interlocutor is detected, applying a predefined first value of an amplification parameter to an intermediate signal generated based on at least one of the first or second input signal; and
if precisely two interlocutors are detected, applying a second value of the amplification parameter to the intermediate signal, with the second value being 2 dB to 5 dB lower than the first value; and
if precisely three interlocutors are detected, applying a third value of the amplification parameter to the intermediate signal, with the third value being 4 dB to 10 dB lower than the first value.

26. The method according to claim 25, which comprises:
generating a first half-space signal and a second half-space signal in each case by the directional microphony based on the first input signal and the second input signal; and
the first half-space signal having a directional characteristic which attenuates a rear half-space to a maximum extent, and the second half-space signal having a directional characteristic which attenuates a front half-space to a maximum extent; and
the front half-space and the rear half-space are defined in relation to a frontal direction of the wearer;
using at least one of an amplification, a noise amplification, or an offset of a background amplification as an amplification factor for the second half-space signal which has a directional characteristic which attenuates a front half-space to a maximum extent.

27. A hearing system, comprising at least a first hearing instrument, and wherein the hearing system is configured to carry out the method according to claim 15.

28. A binaural hearing system, comprising a first hearing instrument with a first input transducer for generating a first input signal from an ambient sound and a second hearing instrument with a second input transducer for generating a second input signal from the ambient sound, said first and second hearing instruments being configured to carry out the method according to claim 15.
